(19) United States
(12) Patent Application Publication
(10) Pub. No.: US 2006/0226223 A1
(43) Pub. Date: Oct. 12, 2006

(54) Socket of card reader (ii) for memory card with connecting terminals following specification of USB containing card-unloading structure

(75) Inventors: An-Yu Yu, Taipei (TW); Lin Tseng-Shyang, Taipei (TW); Yeh Ching-Yi, Taipei (TW); Chang Chi-Sen, Taipei (TW); Chuang Ping-Yang, Taipei (TW)

Correspondence Address: BACON & THOMAS, PLLC, 625 SLATERS LANE, FOURTH FLOOR, ALEXANDRIA, VA, 22314, US

(73) Assignee: Northstar systems Corp., Taipei (TW)

(21) Appl. No.: 11/099,450

(22) Filed: Apr. 6, 2005

(51) Int. Cl. G06K 7/06

(52) U.S. Cl. 235/441

(57) ABSTRACT

The present invention is a socket of card reader (ii) for memory card with connecting terminals following specification of USB containing card-unloading structure, which is a socket of card reader utilizing architecture of USB (Universal Serial Bus) for reading memory card of USB-compatible specification. The said socket of card reader contains a card-unloading structure that allows the memory card to be locked or released by way of pushing. Therefore, in comparison to the existing card reader with numerous connecting terminals, the present invention is apt to be implanted into related informational products.

### BACKGROUND OF THE INVENTION

1) Field of the Invention

The present invention is a socket of card reader (ii) for memory card with connecting terminals following specification of USB containing card-unloading structure, which is a socket of card reader for accepting insertion of memory card with USB 4 pins specification through USB circuit architecture. It is a socket of card reader that applies the existing circuit specification to achieve the connection to a memory card and contains a card-unloading structure.

2) Description of the Prior Art

It is an indisputable fact that flash memory cards have won the favor of electronics market and have been implanted into many related digital products. However, the digital appliances currently produced by different manufacturers had adopted diverse types of memory card. To differentiate from memory cards with distinct specifications, a memory card is typically distinguished through its shape or connecting terminals. Although different memory cards are distinguished by way of different conditions, to keep a design light-weighted, slim, short, and small is always a common target of the designer, that explains the reason why the size of memory card has been reduced to a stamp size. Therefore, “how to make sure that a memory card is reliably inserted into a socket of card reader” has become an important issue.

Accordingly, the present inventor focused on the memory card that following USB 4 pin specification and developed a socket of card reader that contains a card-unloading structure. Although connecting and reading a memory card through USB is not a new technology, as disclosed in the U.S. Pat. No. 6,148,354, “Architecture for a universal serial bus-based PC flash disk”, the present invention features utilizing the existing USB circuit architecture to achieve the connection when a memory card is inserted into a socket of card reader. The said socket of card reader not only additionally provides a push-push mechanism that allows the function of pushing to unload card but as well includes a locking mechanism to prevent unexpected popping and dropping of the memory card.

### SUMMARY OF THE INVENTION

For the socket of card reader (ii) for memory card with connecting terminals following specification of USB containing card-unloading structure according to the present invention, the main purpose is to provide a card-unloading structure in the socket of card reader for memory card with connecting terminals of USB specification, such that the connection and release of memory card can be controlled through pushing and thus ensures the locking or release of memory card.

Lately, many memory cards took bus architecture as connection interface, the present invention not only applied and ameliorated the existing technical resources, but also assured the locking of inserted memory card and thus prevented the memory card from unexpected looseness or getting lost. The key points described above have completely corresponded to the necessary conditions of patent pending. The detailed descriptions as well as the technical contents of the invention shall be given with the accompanying drawings hereunder.

### BRIEF DESCRIPTION OF THE DRAWINGS

FIG. 1 shows an elevational view according to the present invention.

FIG. 2 shows an exploded elevational view according to the present invention.

FIG. 3 shows the exploded elevation viewed from another point according to the present invention.

FIG. 4A shows action I according to the present invention.

FIG. 4B shows action II according to the present invention.

FIG. 4C shows action III according to the present invention.

### DETAILED DESCRIPTION OF THE PREFERRED EMBODIMENTS

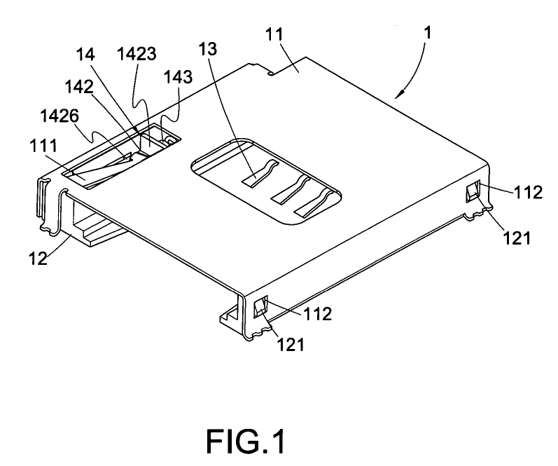

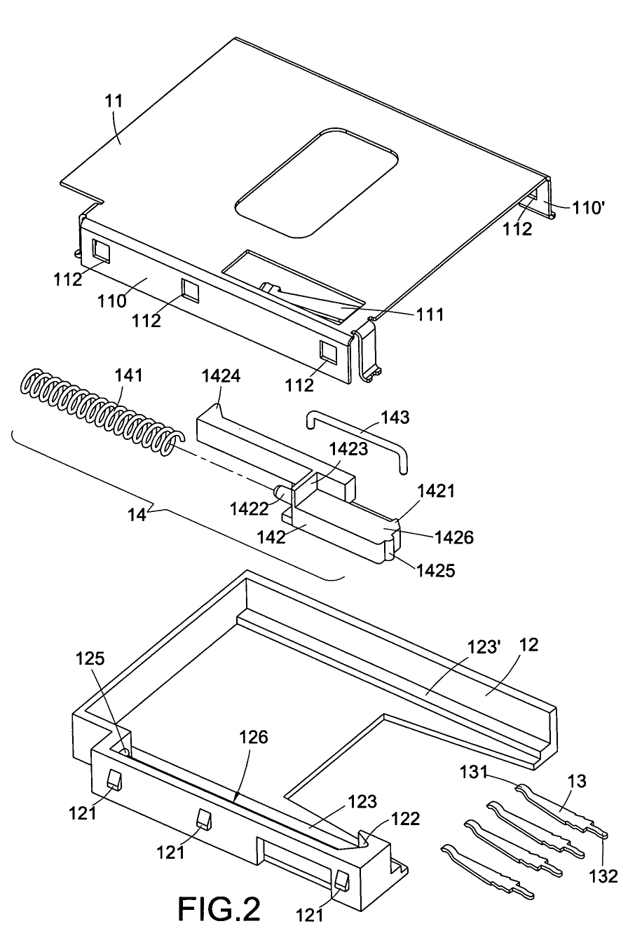

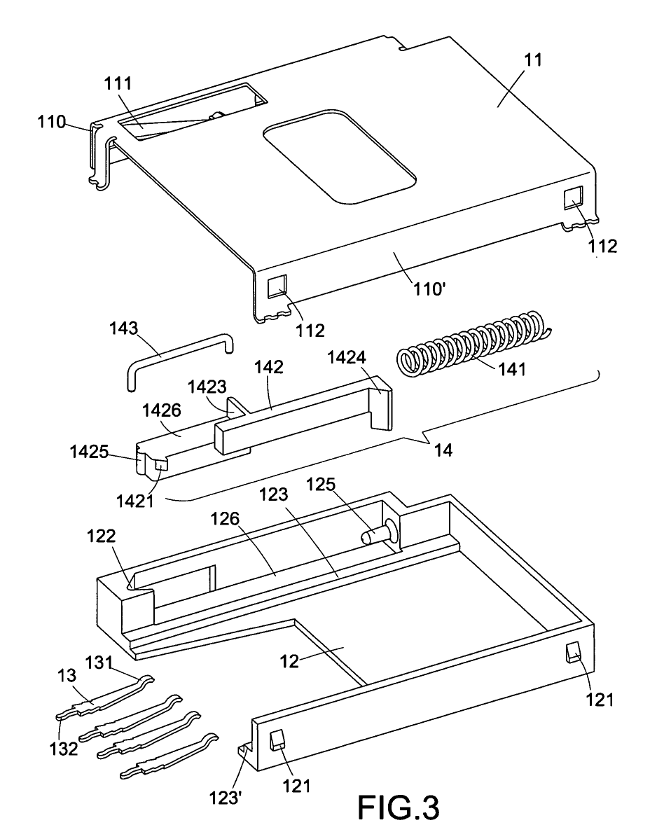

Referring to FIGS. 1, 2, and 3, in which the socket of card reader 1 according to the present invention at least includes a housing 11, a base 12, a card-unloading structure 14, and four connecting terminals 13. The said housing 11 is made from metal material, and is integrally pressed into a form of hollow cube with bottom opened. On the symmetrical bend parts 110, 110′ of housing 11, two locking holes are separately formed to correspond to the locking part 121 of base 12 and serve as locking components for combining base 12 and housing 11. A downward pressing plate 111 is installed atop the housing 11 and corresponds to the concave part 1426 of slide block 142 to resist slide block 142 and thus limits its backward displacement.

The base 12 mainly is used for embedding connecting terminals 13 and thus accepting the insertion of memory card, where two correspondent convex parts 123, 123′ are provided as a track for guiding the insertion of memory card, in which four ways of embedding holes 120 are provided for embedding connecting terminals 13 to achieve the connection when contact to the memory card; further, a slide slot 126 is provided at the convex part 123 such that the slide block 142 of the card-unloading structure 14 can be embedded, and an U-type slot 122 is provided at the front end of slide slot 126 for allocating one end of twin-bend rod 143, while a locating latch 125 is installed at the other end of slide slot 126, the said locating latch 125 is provided for installing spring 141 of card-unloading structure 14.

The said card-unloading structure 14 includes a slide block 142, a twin-bend rod 143, and a spring 141, where the slide block 142 is L-type with one end installed a locking tenon 1421 and another end installed a resist part 1424. The twin-bend rod 143 is installed across the concave part 1426 of slide block 142. The arc part 1425 at end part of slide block 142 is used to control the slide block 142 such that it can be pushed forward to a specified position or retreated. Further, a positioning latch 1422 is installed in front of the concave part 1426 to support the installation of spring 141, where the spring 141 provides a react force to recover the displacement.

Moreover, a bended contact part 131 is bulged on the end part of the said connecting terminals 13. As the connecting terminals 13 are elastically forced to raise, when memory card 2 is inserted, the connecting terminals 13 react to the suppression and contact to the connector of memory card 2, thus complete the connection for reading. Even so, the whole socket of card reader 1 is fixed by welding the weld part 132 (which is located at the connecting terminals 13) to the implanted circuit board.

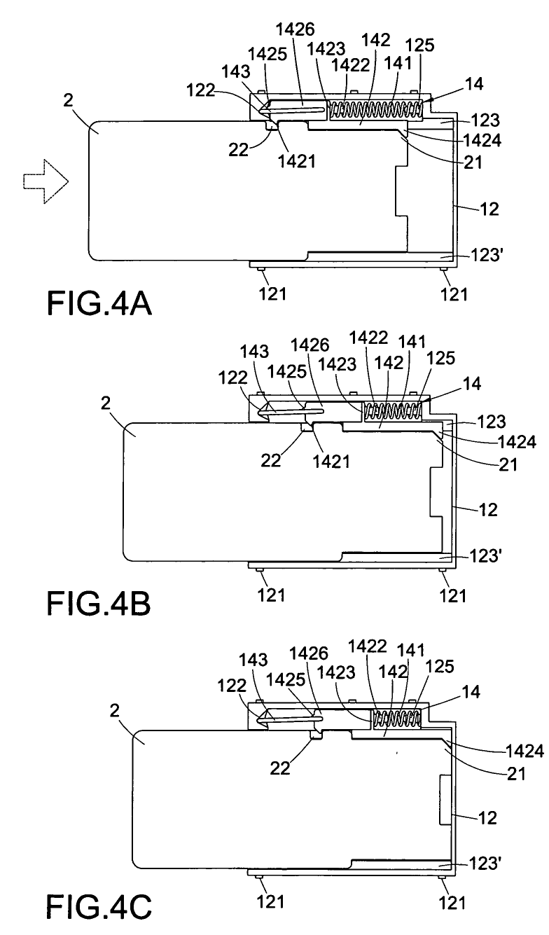

Further, referring to FIG. 4A to 4C, which show the actions of inserting memory card 2. While the font end of memory card 2 touches the resist part 1424 of slide block 142, the lock slot 22 of memory card 2 falls to the locking tenon 1421 of slide block 142 and gets locked. Then, memory card 2 is further pushed to an end (the spring 141 is thus compressed), twin-bend rod 143 is kept at resistant status. After the action of pushing is released, twin-bend rod 143 resists the slide block 142 completely and constrains the slide block 142 to lock memory card 2, wherein the corner cut 21 is correspondent to the resist part 1424 of slide block 142 to prevent incorrect insertion of memory card 2. Pushing memory card 2 again make twin-bend rod 143 escape from the resist of slide block 142, spring 141 is thus released, the slide block 142 is accordingly pushed back, and the memory card 2 is restored to be drawn.

1. A socket of card reader (ii) for memory card with connecting terminals following specification of USB containing card-unloading structure, which is a socket of card reader that read USB-compatible memory card through USB and has a card-unloading structure, in which:
the housing is made from metal material, and is integrally pressed into a form of empty cube with bottom opened, wherein two locking holes are formed on the symmetrical bend parts to correspond to the locking part, and a downward pressing plate is installed atop the housing to correspond to the slide block;
the base is embedded with connecting terminals to accept the insertion of memory card, where two correspondent convex parts are provided as a track for guiding the insertion of memory card, in which a slide slot is provided at the convex part such that the slide block can be embedded, and an U-type slot is provided at the front end of slide slot for allocating one end of twin-bend rod, while a locating latch is installed at the other end for fixing spring;
the said card-unloading structure includes a slide block, a twin-bend rod, and a spring, where the slide block is L-type and is installed beside the base with one end installed a locking tenon and another end installed a resist part, while the twin-bend rod is installed across the slide block and the base, and a spring is installed in front of the sliding block; and
a bended contact part is bulged on the end part of the said connecting terminals, and weld part is provided in front of the connecting terminal in order to be welded and fixed to the implanted circuit board.

2. A socket of card reader (ii) for memory card with connecting terminals following specification of USB containing card-unloading structure in accordance with claim 1, wherein the card-unloading structure can be embodied as elastic plate or stretchable spring.

3. A socket of card reader (ii) for memory card with connecting terminals following specification of USB containing card-unloading structure in accordance with claim 1, wherein the resist part of slide block in card-unloading structure has a slantwise corner cut to correspond to the corner cut of memory card.

4. A socket of card reader (ii) for memory card with connecting terminals following specification of USB containing card-unloading structure in accordance with claim 1, wherein the locking tenon of slide block in card-unloading structure is a locking component to correspond to the locking slot beside the memory card.
